(19) United States
(12) Patent Application Publication
(10) Pub. No.: US 2022/0079155 A1
(43) Pub. Date: Mar. 17, 2022

(54) Herbicidal Combination

(71) Applicant: UPL LTD, Haldia (IN)

(72) Inventors: Ferdinando Marcos Lima Silva, Indianopolis (BR); Flavia Ferreira Megda, Indianopolis (BR)

(21) Appl. No.: 17/419,908

(22) PCT Filed: Jan. 8, 2020
(86) PCT No.: PCT/IB2020/050104

§ 371 Date: Jun. 30, 2021

(30) Foreign Application Priority Data
Jan. 9, 2019 (IN) 201931000998

(51) Int. Cl. A01N 43/80; A01N 57/20; A01N 43/84; A01P 13/00

(52) U.S. Cl. CPC A01N 43/80; A01P 13/00; A01N 43/84; A01N 57/20

(57) ABSTRACT

A herbicidal combination comprising: at least one organophosphorus herbicide; clomazone; and at least one chlorophyll and heme biosynthesis inhibitor for controlling pre-emergent and post-emergent weeds.

### CROSS REFERENCE TO RELATED APPLICATIONS

This application is a National Stage application of PCT/IB2020/050104, filed Jan. 8, 2020, which claims priority to Indian Patent Application 201931000998, filed Jan. 9, 2019, both of which are incorporated by reference in their entirety herein.

### FIELD OF INVENTION

The present invention relates to a herbicidal combination for weeds control in pre and post emergence conditions. More particularly, the present invention relates to a herbicidal combination comprising at least one electrolytic herbicide, at least a second herbicide and a third herbicide for control of broad-leaved weeds and grasses in crops of useful plants.

### BACKGROUND OF THE INVENTION

Herbicides are pesticides useful for killing or controlling unwanted plants. Generally, there are two kinds of herbicides—selective and non-selective. Selective herbicides kill certain target weeds while leaving the desired crop relatively unharmed while non-selective herbicides kill both the weeds and crops. Profitable crop production depends on effective weed control. The weeds can reduce field crop yields by competing for water, sunlight and nutrients. In today's crop production systems, starting off with a good burn-down program is a must as it helps to achieve maximum initial crop growth and reduce weed interference during early stages of the crop cycle. Since the weed-crop competition is critical during the early stages of crop cycle, the weed interference at early stage has a direct impact on the yield of the crop.

An effective weed control can be achieved by usage of herbicides appropriately. The activity of herbicides can be enhanced in various ways to achieve the maximum benefit. One of the ways is to use combinations. However, identifying appropriate combinations, their agrochemical application rates and ratio of the combinations is essential to achieve efficacious control, which is not straight forward. The selection of a particular formulation type is more cumbersome for an agrochemical combination.

Glufosinate is a non-selective foliage application type herbicide which kills or controls many species of weeds. It is reported that glufosinate has been widely used in burn-down segments, and for control of a wide range of broad-leaved weeds and grasses and sedges in cereals, cotton, corn and soy, fruit orchards, vineyards, rubber and oil palm plantations, ornamental trees and bushes, non-crop land, and pre-emergence in vegetables. Conventionally, glufosinate is used in salt form.

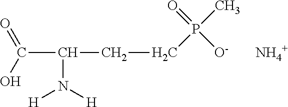

Flumioxazin (N-(7-fluoro-3,4-dihydro-3-oxo-4-prop-2-ynyl-2H-1,4-benzoxazin-6-yl)cyclohex-1-ene-1,2-dicarboxamide) is a dicarboximide herbicide.

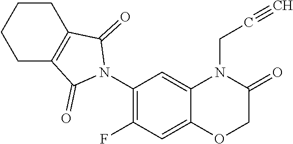 [SMILES: C#CCN1C(=O)COc2cc(F)c(N3C(=O)C4=C(CCCC4)C3=O)cc21]

Flumioxazin is an effective pre-emergence herbicide. Valor® (available from Valent U.S.A. Corporation) contains flumioxazin and is known to provide four to six weeks of pre-emergence control of Palmer amaranth.

Clomazone is the chemical name of compound 2—((2-chlorophenyl) methyl)-4,4-dimethyl-3-isoxazolidinone, having the formula:

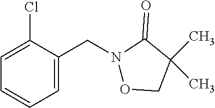 [SMILES: CC1(C)CON(Cc2ccccc2Cl)C1=O]

It is used for broadleaf weed control in several crops, including soybeans, peas, maize, oilseed rape, sugar cane, cassava, pumpkins and tobacco.

The efficacy of these herbicides against harmful weeds in the crop plants depends on the application rate, the formulation ingredients, the harmful weeds to be controlled, the climatic conditions and the soil conditions.

However, there remains a great need for improved broadleaf and grassy weed control compositions and a method of controlling such noxious vegetation in pre and post emergence without adversely affecting desirable plants and which reduces the amount of chemical herbicidal agent necessary to obtain the acceptable weed control.

### One or More Advantages of the Invention

Thus, an object of the present invention is to provide a combination and a method of controlling pre-emergence and post-emergence weeds

Another object of the present invention is to provide a herbicidal combination for weeds control in pre and post emergence conditions.

Another object of the present invention is to provide a herbicidal combination for improved broadleaf and grassy weed control without adversely affecting desirable plants.

Another object of the present invention is to provide a herbicidal combination which reduces the amount of chemical herbicidal agent necessary to obtain the acceptable weed control.

### SUMMARY OF THE INVENTION

Therefore, in one aspect, the present invention may provide a herbicidal combination comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

In another aspect, the present invention may provide a method of controlling weeds at a locus, said method comprising applying to the locus a herbicidal combination comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

In an aspect, the present invention may provide a herbicidal composition comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone;
(c) at least one chlorophyll and heme biosynthesis inhibitor; and
(d) at least one agrochemically acceptable excipient.

Another aspect of the present invention is to provide a method of controlling the weeds wherein said method comprising application at the locus of the plant a combination comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

Another aspect of the present invention is to provide a method of controlling the weeds selected from but not limited to Brachiaria decumbens, Conyza spp. and Cenchrus echinatus, Ipomoea grandifolia, Euphorbia heterophylla said method comprising application at the locus of the plant a combination comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

### DETAILED DESCRIPTION OF THE INVENTION

The term herbicide, as used herein, shall mean an active ingredient that kills, controls or otherwise adversely modifies the growth of weeds. As used herein, a herbicidally effective or vegetation controlling amount is an amount of active ingredient that causes a “herbicidal effect,” i.e., an adversely modifying effect and includes deviations from natural development, killing, regulation, desiccation, retardation. The terms “plants” and “vegetation” include, but are not limited to, germinant seeds, emerging seedlings, plants emerging from vegetative propagules, and established vegetation. The term “locus” as used herein shall denote the vicinity of a desired crop in which weed control, typically selective weed control, of weeds is desired. The locus includes the vicinity of desired crop plants wherein the weed infestation has either emerged or is yet to emerge. The term crop shall include a multitude of desired crop plants or an individual crop plant growing at a locus.

Surprisingly, it has been found by the present inventors that a combination of an organophosphorus herbicide with clomazone results in a synergistic control of undesirable plants at the locus of the desired plant in the presence of at least one chlorophyll and heme biosynthesis inhibitor. Surprisingly, it was found that the synergistic correlation between the organophosphorus herbicide and clomazone depended primarily on the presence of at least one chlorophyll and heme biosynthesis inhibitor.

Therefore, in one aspect, the present invention may provide a herbicidal combination comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

In an embodiment, the herbicidal combinations of the present invention comprise one herbicide from the class of an organophosphorus herbicide and one herbicide from the class of chlorophyll and heme biosynthesis inhibitors along with clomazone.

In another aspect, the present invention provides a method of controlling weeds at a locus by applying the combination of the present invention to the locus.

Thus, in this aspect, the present invention may provide a method of controlling weeds at a locus, said method comprising applying to the locus a combination comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

In another aspect, the present invention provides a composition comprising the combinations of the present invention.

Therefore, in this aspect, the present invention may provide a composition comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone;
(c) at least one chlorophyll and heme biosynthesis inhibitor; and
(d) at least one agrochemically acceptable excipient.

Each of the aspect described above may have one or more embodiments.

Each of the embodiments described hereinafter may apply to one or all of the aspects described hereinabove. These embodiments are intended to be read as being preferred features of one or all of the aspects described hereinabove. Each of the embodiments described hereinafter applies to each of the aspects described hereinabove individually.

In an embodiment, the organophosphorus herbicide is glufosinate.

Therefore, in this embodiment, the present invention may provide a combination comprising:
(a) glufosinate;
(b) clomazone; and
(c) at least one chlorophyll and heme biosynthesis inhibitor.

In an embodiment, the organophosphorus herbicide is glufosinate-P.

Therefore, in this embodiment, the present invention may provide a combination comprising:
(a) glufosinate-P;
(b) clomazone; and
(c) at least one chlorophyll and heme biosynthesis inhibitor.

In an embodiment, the organophosphorus herbicide is glyphosate.

Therefore, in this embodiment, the present invention may provide a combination comprising:
(a) glyphosate;
(b) clomazone; and
(c) at least one chlorophyll and heme biosynthesis inhibitor.

In an embodiment, the combinations of the present invention comprise a chlorophyll and heme biosynthesis inhibitor.

In an embodiment, the chlorophyll and heme biosynthesis inhibitor is a triazolone herbicide.

In an embodiment, the triazolone herbicide is selected from the group consisting of amicarbazone, bencarbazone, carfentrazone, flucarbazone, ipfencarbazone, propoxycarbazone, sulfentrazone, and thiencarbazone.

In an embodiment, the triazolone herbicide is carfentrazone.

In an embodiment, the triazolone herbicide is flucarbazone.

In an embodiment, the triazolone herbicide is sulfentrazone.

In an embodiment, the triazolone herbicide is amicarbazone.

In an embodiment, the chlorophyll and heme biosynthesis inhibitor is a uracil herbicide.

In an embodiment, the uracil herbicide is selected from the group consisting of benzfendizone, bromacil, butafenacil, flupropacil, isocil, lenacil, saflufenacil, terbacil and tiafenacil.

In an embodiment, the uracil herbicide is bromacil.

In an embodiment, the uracil herbicide is saflufenacil.

In an embodiment, the chlorophyll and heme biosynthesis inhibitor is a dicarboximide herbicide.

In an embodiment, the dicarboximide herbicide is selected from the group consisting of cinidon-ethyl, flumezin, flumiclorac, flumioxazin, and flumipropyn.

In an embodiment, the dicarboximide herbicide is flumioxazin.

In an embodiment, the chlorophyll and heme biosynthesis inhibitor is a pyrazole herbicide.

In an embodiment, the pyrazole herbicide is selected from the group consisting of azimsulfuron, cyclopyranil, difenzoquat, halosulfuron, metazachlor, flazasulfuron, metazosulfuron, pyrazosulfuron, pyraclonil, pyroxasulfone, benzofenap, pyrasulfotole, pyrazolynate, pyrazoxyfen, tolpyralate, topramezone, fluazolate, nipyraclofen, pinoxaden, and pyraflufen.

In an embodiment, the pyrazole herbicide is halosulfuron.

In an embodiment, the pyrazole herbicide is flazasulfuron.

In an embodiment, the pyrazole herbicide is pyrazosulfuron.

In an embodiment, the pyrazole herbicide is metazachlor.

In an embodiment, the pyrazole herbicide is pinoxaden.

In an embodiment, the pyrazole herbicide is pyraflufen.

In an embodiment, the chlorophyll and heme biosynthesis inhibitor is selected from the group consisting of carfentrazone, amicarbazone, flucarbazone, sulfentrazone, bromacil, saflufenacil, flumioxazin, halosulfuron, flazasulfuron, pyrazosulfuron, metazachlor, amicarbazone, pinoxaden, and pyraflufen.

Thus, in an embodiment, the present invention provides a herbicidal combination comprising:
(a) at least one organophosphorus herbicide selected from glufosinate, glufosinate-P, and glyphosate;
(b) clomazone; and
(c) at least one chlorophyll and heme biosynthesis inhibitor selected from the group consisting of carfentrazone, amicarbazone, flucarbazone, sulfentrazone, bromacil, saflufenacil, flumioxazin, halosulfuron, flazasulfuron, pyrazosulfuron, metazachlor, amicarbazone, pinoxaden, and pyraflufen.

In an embodiment, the present invention provides preferred combinations, compositions and methods thereof. The methods of the invention include a method of controlling weeds at a locus by applying to the locus the combination or the composition. The embodiments described herein describe the preferred embodiments of all these possible combinations, compositions and methods of the invention.

In an embodiment, the organophosphorus herbicide is selected from glufosinate, glufosinate-P, and glyphosate; and the chlorophyll and heme biosynthesis inhibitor is selected from the group consisting of carfentrazone, amicarbazone, flucarbazone, sulfentrazone, bromacil, saflufenacil, flumioxazin, halosulfuron, flazasulfuron, pyrazosulfuron, metazachlor, amicarbazone, pinoxaden, and pyraflufen.

In an embodiment, the organophosphorus herbicide is glufosinate, and the chlorophyll and heme biosynthesis inhibitor is carfentrazone.

In an embodiment, the organophosphorus herbicide is glufosinate, and the chlorophyll and heme biosynthesis inhibitor is amicarbazone.

In an embodiment, the organophosphorus herbicide is glufosinate, and the chlorophyll and heme biosynthesis inhibitor is flucarbazone.

In an embodiment, the organophosphorus herbicide is glufosinate, and the chlorophyll and heme biosynthesis inhibitor is sulfentrazone.

In an embodiment, the organophosphorus herbicide is glufosinate, and the chlorophyll and heme biosynthesis inhibitor is bromacil.

In an embodiment, the organophosphorus herbicide is glufosinate, and the chlorophyll and heme biosynthesis inhibitor is saflufenacil.

In an embodiment, the organophosphorus herbicide is glufosinate, and the chlorophyll and heme biosynthesis inhibitor is flumioxazin.

In an embodiment, the organophosphorus herbicide is glufosinate, and the chlorophyll and heme biosynthesis inhibitor is halosulfuron.

In an embodiment, the organophosphorus herbicide is glufosinate, and the chlorophyll and heme biosynthesis inhibitor is flazasulfuron.

In an embodiment, the organophosphorus herbicide is glufosinate, and the chlorophyll and heme biosynthesis inhibitor is pyrazosufuron.

In an embodiment, the organophosphorus herbicide is glufosinate, and the chlorophyll and heme biosynthesis inhibitor is metazachlor.

In an embodiment, the organophosphorus herbicide is glufosinate, and the chlorophyll and heme biosynthesis inhibitor is pinoxaden.

In an embodiment, the organophosphorus herbicide is glufosinate, and the chlorophyll and heme biosynthesis inhibitor is pyraflufen.

In an embodiment, the organophosphorus herbicide is glufosinate-P, and the chlorophyll and heme biosynthesis inhibitor is carfentrazone.

In an embodiment, the organophosphorus herbicide is glufosinate-P, and the chlorophyll and heme biosynthesis inhibitor is amicarbazone.

In an embodiment, the organophosphorus herbicide is glufosinate-P, and the chlorophyll and heme biosynthesis inhibitor is flucarbazone.

In an embodiment, the organophosphorus herbicide is glufosinate-P, and the chlorophyll and heme biosynthesis inhibitor is sulfentrazone.

In an embodiment, the organophosphorus herbicide is glufosinate-P, and the chlorophyll and heme biosynthesis inhibitor is bromacil.

In an embodiment, the organophosphorus herbicide is glufosinate-P, and the chlorophyll and heme biosynthesis inhibitor is saflufenacil.

In an embodiment, the organophosphorus herbicide is glufosinate-P, and the chlorophyll and heme biosynthesis inhibitor is flumioxazin.

In an embodiment, the organophosphorus herbicide is glufosinate-P, and the chlorophyll and heme biosynthesis inhibitor is halosulfuron.

In an embodiment, the organophosphorus herbicide is glufosinate-P, and the chlorophyll and heme biosynthesis inhibitor is flazasulfuron.

In an embodiment, the organophosphorus herbicide is glufosinate-P, and the chlorophyll and heme biosynthesis inhibitor is pyrazosufuron.

In an embodiment, the organophosphorus herbicide is glufosinate-P, and the chlorophyll and heme biosynthesis inhibitor is metazachlor.

In an embodiment, the organophosphorus herbicide is glufosinate-P, and the chlorophyll and heme biosynthesis inhibitor is pinoxaden.

In an embodiment, the organophosphorus herbicide is glufosinate-P, and the chlorophyll and heme biosynthesis inhibitor is pyraflufen.

In an embodiment, the organophosphorus herbicide is glyphosate, and the chlorophyll and heme biosynthesis inhibitor is carfentrazone.

In an embodiment, the organophosphorus herbicide is glyphosate, and the chlorophyll and heme biosynthesis inhibitor is amicarbazone.

In an embodiment, the organophosphorus herbicide is glyphosate, and the chlorophyll and heme biosynthesis inhibitor is flucarbazone.

In an embodiment, the organophosphorus herbicide is glyphosate, and the chlorophyll and heme biosynthesis inhibitor is sulfentrazone.

In an embodiment, the organophosphorus herbicide is glyphosate, and the chlorophyll and heme biosynthesis inhibitor is bromacil.

In an embodiment, the organophosphorus herbicide is glyphosate, and the chlorophyll and heme biosynthesis inhibitor is saflufenacil.

In an embodiment, the organophosphorus herbicide is glyphosate, and the chlorophyll and heme biosynthesis inhibitor is flumioxazin.

In an embodiment, the organophosphorus herbicide is glyphosate, and the chlorophyll and heme biosynthesis inhibitor is halosulfuron.

In an embodiment, the organophosphorus herbicide is glyphosate, and the chlorophyll and heme biosynthesis inhibitor is flazasulfuron.

In an embodiment, the organophosphorus herbicide is glyphosate, and the chlorophyll and heme biosynthesis inhibitor is pyrazosufuron.

In an embodiment, the organophosphorus herbicide is glyphosate, and the chlorophyll and heme biosynthesis inhibitor is metazachlor.

In an embodiment, the organophosphorus herbicide is glyphosate, and the chlorophyll and heme biosynthesis inhibitor is pinoxaden.

In an embodiment, the organophosphorus herbicide is glyphosate, and the chlorophyll and heme biosynthesis inhibitor is pyraflufen.

These combinations may be applied to the locus of the weeds, in an herbicidally effective amount.

In an embodiment, the combination of the present invention may be combined with at least another active ingredient such as those selected from but not limited to herbicide, insecticide, fungicide, biological agent, plant growth activator, fertilizers or combinations thereof.

Thus, in an embodiment, the combination of the present invention may be combined with another herbicide. Exemplary herbicides that may be combined with the combination of the present invention may be selected from but not limited to herbicides belonging to classes such as EPSP synthase inhibitors, synthetic auxins, auxin transport inhibitors, glutamate synthase inhibitors, HPPD inhibitors, lipid synthesis inhibitors, long chain fatty acid inhibitors, as well as herbicides with unknown modes of action.

In an embodiment, the total amount of the organophosphorus herbicide in the composition may be in the range of 0.1 to 99% by weight, preferably 0.2 to 90% by weight.

In an embodiment, the total amount of the heme and chlorophyll biosynthesis inhibitor in the composition may be in the range of 0.1 to 99% by weight.

In an embodiment, the constituent herbicides of the combination of the present invention may be admixed in ratio of (1-80):(1-80):(1-80) of the three herbicides respectively.

In another embodiment the combination of organophosphorus herbicide, clomazone; chlorophyll and heme biosynthesis inhibitor is in the ratio of 1:0.12-0.13:1.2-1.9.

In another embodiment the combination of organophosphorus herbicide, clomazone; chlorophyll and heme biosynthesis inhibitor is in the ratio of one—1.0:0.175:1.25 or Two—1.0:0.138:1.25; or Three—1.0:0.138:1.875.

The herbicidal combination of the present invention may be used to target weeds among the crops such corn, rice, wheat, barley, rye, oat, sorghum, cotton, soybean, peanut, buckwheat, beet, rapeseed, sunflower, sugar cane, tobacco, etc.; vegetables: solanaceous vegetables such as eggplant, tomato, pimento, pepper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc, liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc, strawberry, sweet potato, Dioscorea japonica, colocasia, etc., flowers, foliage plants, turf grasses, fruits: pome fruits such apple, pear, quince, etc, stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, zelkova, Japanese arborvitae, fir wood, hemlock, juniper, Pinus, Picea, and Taxus cuspidate, etc.

In an embodiment, the composition of the present invention may contain agriculturally acceptable adjuvants, carriers, diluents, emulsifiers, fillers, anti-foaming agents, thickening agents, anti-freezing agents, freezing agents etc. The compositions may be either solid or liquids. They can be solids, such as, for example, dusts, granules, water-dispersible granules, microcapsules or wettable powders, or liquids, such as, for example, emulsifiable concentrates, solutions, emulsions or suspensions, ZC formulations. They can also be provided as a pre-mix or tank mixed.

Suitable agricultural adjuvants and carriers may include, but are not limited to, crop oil concentrates; methylated seed oils, emulsified methylated seed oil, nonylphenol ethoxylate; benzylcocoalkyldimethyl quaternary ammonium salt; blend of petroleum hydrocarbon, alkyl esters, organic acid, and anionic surfactant; C9-C11 alkylpolyglycoside; phosphated alcohol ethoxylate; natural primary alcohol (C12-C16) ethoxylate; di-sec-butylphenol EO-PO block copolymer; polysiloxane-methyl cap; nonylphenol ethoxylate, urea ammonium nitrate; tridecyl alcohol (synthetic) ethoxylate (8EO); tallow amine ethoxylate; PEG(400) dioleate-99, alkyl sulfates, such as diethanolammonium lauryl sulfate; alkylarylsulfonate salts, such as calcium dodecylbenzenesulfonate; alkylphenol-alkylene oxide addition products, such as nonylphenol-C18 ethoxylate; alcohol-alkylene oxide addition products, such as tridecyl alcohol-C16 ethoxylate; soaps, such as sodium stearate; alkyl-naphthalene-sulfonate salts, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable or seed oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, and in certain embodiments, methyl esters.

Suitable liquid carriers that may be employed in a composition of the present invention may include water or organic solvents. The organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Organic solvents include, but are not limited to toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide.

Solid carriers that may be employed in the compositions of the present invention may include but are not limited to attapulgite, pyrophyllite clay, silica, kaolin clay, kieselguhr, chalk, diatomaceous earth, lime, calcium carbonate, bentonite clay, Fuller's earth, talc, cottonseed hulls, wheat flour, soybean flour, pumice, wood flour, walnut shell flour, lignin, cellulose etc.

The target weeds may be selected from Alopecurus myosuroides Huds. (blackgrass, ALOMY), Amaranthus palmeri (Palmer amaranth, AMAPA) Amaranthus viridis (slender amaranth, AMAVI), Avena fatua (wild oat, AVEFA), Brachiaria decumbens Stapf. or Urochloa decumbens (Stapf), Brachiaria brizantha or Urochloa brizantha, Brachiaria platyphylla (Groseb.) Nash or Urochloa platyphylla (broadleaf signalgrass, BRAPP), Brachiaria plantaginea. or Urochloa plantaginea (alexandergrass, BRAPL), Cenchrus echinatus (southern sandbur, CENEC), Digitaria horizontalis Willd. (Jamaican crabgrass, DIGHO), Digitaria insularis (sourgrass, TRCIN), Digitaria sanguinalis (large crabgrass, DIGSA), Echinochloa crus-galli (barnyardgrass, ECHCG), Echinochloa colonum (junglerice, ECHCO), Eleusine indica Gaertn. (goosegrass, ELEIN), Lolium multiflorum Lam. (Italian ryegrass, LOLMU), Panicum dichotomiflorum Michx. (fall panicum, PANDI), Panicum miliaceum L. (wild-proso millet, PANMI), Sesbania exaltata (hemp sesbania, SEBEX), Setaria faberi Herrm. (giant foxtail, SETFA), Setaria viridis (green foxtail, SETVI), Sorghum halepense (Johnsongrass, SORHA), Sorghum bicolor, Moench ssp., Arundinaceum (shattercane, SORVU), Cyperus esculentus (yellow nutsedge, CYPES), Cyperus rotundus (purple nutsedge, CYPRO), Abutilon theophrasti (velvetleaf, ABUTH), Amaranthus species (pigweeds and amaranths, AMASS), Ambrosia artemisiifolia L. (common ragweed, AMBEL), Ambrosia psilostachya DC. (western ragweed, AMBPS), Ambrosia trifida (giant ragweed, AMBTR), Anoda cristata (spurred anoda, ANVCR), Asclepias syriaca (common milkweed, ASCSY), Bidens pilosa (hairy beggarticks, BIDPI), Borreria species (BOISS), Borreria alata or Spermacoce alata Aubl. or Spermacoce latifolia (broadleaf buttonweed, BOILF), Chenopodium album L. (common lambsquarters, CHEAL), Cirsium arvense (Canada thistle, CIRAR), Commelina benghalensis (tropical spiderwort, COMBE), Datura stramonium (jimsonweed, DATST), Daucus carota (wild carrot, DAUCA), Euphorbia heterophylla (wild poinsettia, EPHHL), Euphorbia hirta or Chamaesyce hirta (garden spurge, EPHHI), Euphorbia dentata Michx. (toothed spurge, EPHDE), Erigeron bonariensis or Conyza bonariensis (hairy fleabane, ERIBO), Erigeron canadensis or Conyza canadensis (horseweed, ERICA), Conyza sumatrensis (tall fleabane, ERIFL), Helianthus annuus (common sunflower, HELAN), Jacquemontia tamnifolia (smallflower morningglory, IAQTA), Ipomoea hederacea (ivyleaf morningglory, IPOHE), Ipomoea lacunosa (white morningglory, IPOLA), Lactuca serriola (prickly lettuce, LACSE), Portulaca oleracea (common purslane, POROL), Richardia species (pusley, RCHSS), Salsola tragus (Russian thistle, SASKR), Sida species (sida, SIDSS), Sida spinosa (prickly sida, SIDSP), Sinapis arvensis (wild mustard, SINAR), Solanum ptychanthum (eastern black nightshade, SOLPT), Tridax procumbens (coat buttons, TRQPR), Rumex dentatus (RUMDE) or Xanthium strumarium (common cocklebur, XANST).

In an embodiment, the combinations of the present invention may be applied to the locus either simultaneously or sequentially, such that the three herbicides may be applied in a tank mix or as a pre-mixed composition.

Thus, in this aspect, the present invention provides a tank-mix combination comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

In another aspect of the present invention is to provide a method of controlling the weeds selected from but not limited to Brachiaria decumbens, Conyza spp. and Cenchrus echinatus, Ipomoea grandifolia, Euphorbia heterophylla said method comprising application at the locus of the plant a combination comprising:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

In an embodiment, the present invention may be applied either pre or post emergent. The advantage of the combination is surprisingly good residual effects, when applied in pre-emergent as well as quick knockdown when applied post emergent leading to quick control of weeds. In another embodiment, the present invention may be applied for quick burndown of weeds. Another advantage is quick knockdown in the case of burndown.

In an embodiment, the present invention is more preferably applied pre-emergent of the weed to get better control.

The method of control of the present invention may be carried out by spraying the suggested tank mixes, or the individual herbicides may be formulated as a kit-of-parts containing various components that may be mixed as instructed prior to spraying.

In an embodiment, the present invention provides a kit-of-parts comprising a plurality of components, wherein said plurality of components comprises:
(a) at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
(b) clomazone; and
(c) at least one chlorophyll and heme biosynthesis inhibitor.

In an embodiment, the kit-of-parts comprises an instructions manual, said instructions manual comprising instructions directing a user to admix the components before being used.

In an embodiment, the components of the present invention may be packaged such that the organophosphorus herbicide, clomazone and the chlorophyll and heme biosynthesis inhibitor may be packaged separately and then tank mixed before the spraying.

In another embodiment, the components of the present invention may be packaged such that the organophosphorus herbicide, clomazone and the chlorophyll and heme biosynthesis inhibitor may be packaged separately, whereas other additives are packaged separately, such that the two may be tank mixed at the time of spraying.

In another embodiment, the components of the present invention may be packaged as composition such that the organophosphorus herbicide, clomazone and the chlorophyll and heme biosynthesis inhibitor are formulated into one composition and other additives are packaged separately, such that the two may be tank mixed at the time of spraying.

Surprisingly, it has been found by the present inventors, the organophosphorus herbicide, clomazone and the chlorophyll and heme biosynthesis inhibitor of the present invention, when applied individually, was ineffective in the control of weeds, but demonstrated excellent synergistic control on when applied together. The combination controlled the weed both pre and post emergently. As will be demonstrated by the examples, the combination of the organophosphorus herbicide, clomazone and the chlorophyll and heme biosynthesis inhibitor synergistically controlled broadleaf as well as grasses and sedges at a locus. The current invention therefore provides advantageous methods of controlling weeds both pre and post emergently. The present method also provides a broader spectrum of controlling weeds that helps in resistance management, thus preventing the weed from becoming resistant to either of the herbicides while providing a broader spectrum of control at lower use rates.

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification. Unless otherwise defined, all technical and scientific terms used herein have the same meaning as commonly understood by one of ordinary skill in the art to which this invention pertains. In the case of conflict, the present document, including definitions will control.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The term herbicide, as used herein, shall mean an active ingredient that kills, controls or otherwise adversely modifies the growth of plants. As used herein, a herbicidally effective or vegetation controlling amount is an amount of active ingredient that causes a “herbicidal effect,” i.e., an adversely modifying effect and includes deviations from natural development, killing, regulation, desiccation, retardation.

The term “Electrolytic”, as used herein, means capable of creating an aqueous solution during dilution containing free ions that behaves as an electrically conductive medium.

The terms “plants” and “vegetation” include, but are not limited to, germinant seeds, emerging seedlings, plants emerging from vegetative propagules, and established vegetation. The term “weed” refers to and includes any plant which grows where it is not wanted, including pesticide resistant plants.

The term “locus” as used herein shall denote the vicinity of a desired crop in which weed control, typically selective weed control is desired. The locus includes the vicinity of desired crop plants wherein the weed infestation has either emerged or is yet to emerge. The term crop shall include a multitude of desired crop plants or an individual crop plant growing at a locus.

Surprisingly, the present inventors have now found that when the combination of the organophosphorus herbicide, clomazone and the chlorophyll and heme biosynthesis inhibitor was mixed, the resultant combination showed improved synergistic effect. It was surprising that even a reduced amount of the combination of the present invention resulted in unexpectedly enhancing the efficacy of a combination for controlling undesired weeds.

Surprisingly, it has been found that the active compound combinations or compositions according to the invention do not only exhibit an additive effect of the activity of the individual components but exert a synergistic effect when used in combination. Therefore, firstly, the customary application rates of the individual substances were reduced.

According to the present invention the compositions are useful as herbicides, demonstrating enhanced broad-spectrum control of weeds and unwanted vegetation. Unexpectedly, inventors of the present invention have been able to prepare agrochemical compositions comprising combination of at least one organophosphorus herbicide, clomazone and the chlorophyll and heme biosynthesis inhibitor for pre and post emergence weed control.

The herbicidal compositions of present invention also preferably comprise an agriculturally acceptable carrier/adjuvant/excipient.

In an embodiment, glufosinate is present in the present composition in an amount of 1% to 50%, preferably 3% to 35%, more preferably 5% to 20%, preferably about 10%.

In an embodiment, flumioxazin is present in the present composition in an amount of 1% to 50%, preferably 3% to 35%, more preferably 5% to 20%, preferably 10%.

The present compositions comprise clomazone in an amount of 5% to 20%, preferably 1% to 50%, preferably 3% to 35%, more preferably 10%.

The invention will now be described in more details with reference to the following examples. While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, ratios of the herbicides or the following examples, but by all embodiments and methods within the scope and spirit of the invention.

### EXAMPLES

### Materials and Methods

Field trials were conducted on various weeds and the effect of combination was studied to understand the selective and effective control of weeds.

Studies were conducted to compare the weed controlling activity of the combination of Glufosinate, Flumioxazin and Clomazone and compare its observed efficacy with the “expected” efficacy when Glufosinate, Flumioxazin and Clomazone were used. Any difference between the observed and “expected” efficacy could be attributed to synergy between the compounds in the control of weeds. The expected efficacy of a combination of Glufosinate, Flumioxazin and Clomazone was calculated using the well-established Colby method.

In the Colby method, the expected (or predicted) response of a combination of herbicides is calculated by taking the product of the observed response for each individual component of the combination when applied alone divided by 100 and subtracting this value from the sum of the observed response for each component when applied alone. An unexpected enhancement in efficacy of the combination is then determined by comparing the observed response of the combination to the expected (or predicted) response as calculated from the observed response of each individual component alone. If the observed response of the combination is greater than the expected (or predicted) response, or stated conversely, if the difference between the observed and expected response is greater than zero, then the combination is said to be synergistic or unexpectedly effective, (Colby, S. R.: Weeds, 1967(15), p. 20-22} The Colby method requires only a single dose of each herbicide applied alone and the mixture of both doses. The formula used to calculate the expected efficacy (EE) which was compared with the observed efficacy (OE) to determine the efficacy of the present invention is explained herein below:

The weed control activity of the individual herbicides of the invention and their combinations were evaluated on weeds such as Ipomoea grandifolia (IAQGR), Brachiaria decumbens (BRADC) and Euphorbia heterophylla (EPHHL). The trial was carried out in Randomized Complete Biock (RCB) method, all field trials were conducted using this method. Each trial were replicated four times and conducted under GEP guidelines. Application volumes were varied for each mixture. Such field trials were carried out at various locations so as to generate independent data, the locations were chosen randomly, Glufosinate, Flumioxazin and Clomazone were sprayed according to their recommended dosage.

The following formula was used to calculate the expected activity of mixtures containing three active ingredients, A, B and C:

$$Expected control = A + B + C - \frac{( AB + AC + BC )}{100} + \frac{ABC}{10000}$$

### Where

A=observed efficacy of active ingredient A at the same concentration as used in the mixture.
B=observed efficacy of active ingredient B at the same concentration as used in the mixture.
C=observed efficacy of active ingredient C at the same concentration as used in the mixture.

The herbicide tank mix combinations, application rates, plant species tested, and results are given in the following examples:

### Example 1

The herbicidal formulations according to the present invention are as provided as follows.

| | | | | G ai/ha | | | Dose Kg or L/ha | | |
|---|---|---|---|---|---|---|---|---|---|
| | | | | Dose | Dose | Dose | Dose | Dose | Dose |
| | Product | Active | concentration | 100% | 75% | 50% | 100% | 75% | 50% |
| Ratio | UPL 323 | Glufosinate | 200 | 400 | 300 | 200 | 2.00 | 1.50 | 1.00 |
| 1 | Flumyzin | Flumioxazin | 500 | 70 | 52.5 | 35 | 0.14 | 0.11 | 0.07 |
| | upstage | clomazone | 500 | 500 | 375 | 250 | 1.00 | 0.75 | 0.50 |
| Ratio | UPL 323 | Glufosinate | 200 | 400 | 300 | 200 | 2.00 | 1.50 | 1.00 |
| 2 | Flumyzin | Flumioxazin | 500 | 55 | 41.25 | 27.5 | 0.11 | 0.08 | 0.06 |
| | upstage | clomazone | 500 | 500 | 375 | 250 | 1.00 | 0.75 | 0.50 |
| Ratio | UPL 323 | Glufosinate | 200 | 400 | 300 | 200 | 2.00 | 1.50 | 1.00 |
| 3 | Flumyzin | Flumioxazin | 500 | 55 | 41.25 | 27.5 | 0.11 | 0.08 | 0.06 |
| | upstage | clomazone | 500 | 750 | 562.5 | 375 | 1.50 | 1.13 | 0.75 |

| Treat # | Ratios | Product | ai | Dose Lor kg/ha | g ai/ha |
|---|---|---|---|---|---|
| 1. | | check | | | |
| 2. | | UPL 323 | Glufosinato (200) | 1.00 | 200 |
| 3. | | UPL 323 | Glufosinato (200) | 1.50 | 300 |
| 4. | | Flumyzin | Flumioxazin (500) | 0.06 | 27.50 |
| 5. | | Flumyzin | Flumioxazin (500) | 0.07 | 35.00 |
| 6. | | Flumyzin | Flumioxazin (500) | 0.08 | 41.25 |
| 7. | | Flumyzin | Flumioxazin (500) | 0.11 | 52.50 |
| 8. | | Up-Stage | Clomazone (500) | 0.5 | 250.00 |
| 9. | | Up-Stage | Clomazone (500) | 0.8 | 375.00 |
| 10. | | Up-Stage | Clomazone (500) | 1.13 | 562.50 |
| 11. | 50% Ratio 1 | UPL 323 | Glufosinato (200) | 1.00 | 200 |
| | | Flumyzin | Flumioxazin (500) | 0.07 | 35.00 |
| | | Up-Stage | Clomazone (500) | 0.5 | 250.00 |
| 12. | 75% Ratio 1 | UPL 323 | Glufosinato (200) | 1.50 | 300 |
| | | Flumyzin | Flumioxazin (500) | 0.11 | 52.50 |
| | | Up-Stage | Clomazone (500) | 0.8 | 375.00 |
| 13. | 50% Ratio 2 | UPL 323 | Glufosinato (200) | 1.00 | 200 |
| | | Flumyzin | Flumioxazin (500) | 0.06 | 27.50 |
| | | Up-Stage | Clomazone (500) | 0.5 | 250.00 |
| 14. | 75% Ratio 2 | UPL 323 | Glufosinato (200) | 1.50 | 300 |
| | | Flumyzin | Flumioxazin (500) | 0.08 | 41.25 |
| | | Up-Stage | Clomazone (500) | 0.8 | 375.00 |
| 15. | 50% Ratio 3 | UPL 323 | Glufosinato (200) | 1.00 | 200 |
| | | Flumyzin | Flumioxazin (500) | 0.06 | 27.50 |
| | | Up-Stage | Clomazone (500) | 0.8 | 375.00 |
| 16. | 75% Ratio 3 | UPL 323 | Glufosinato (200) | 1.50 | 300 |
| | | Flumyzin | Flumioxazin (500) | 0.08 | 41.25 |
| | | Up-Stage | Clomazone (500) | 1.13 | 562.50 |

The herbicidal action of the combination according to the invention was demonstrated by the following field experiments.

### Field Trial

Field experiments were conducted in greenhouse at Ituverava, Brazil to evaluate weed management systems. A synergistic effect is always given when the effect of the combination of three compounds is greater than the sum of the effect of the active compounds applied on their own. The percentage efficacy was calculated after 28 days of applications.

The composition according to the invention is suitable for all economically customary application methods, for example pre-emergent application and post-emergent application.

The treatment trial against target weed namely Ipomoea grandifolia (IAQGR), Brachiaria decumbens (BRADC) and Euphorbia heterophylla (EPHHL) in pre and post emergence application was carried out and the results are recorded in the table below:

### Analysis of Post-Emergent Herbicidal Action of Present Combination on Broadleaf and Grass Weeds

| | | Glufosinate | | |
|---|---|---|---|---|
| | | 400 g/ha + | | |
| | | Flumioxazin | | |
| | | 70 g/ha + | | |
| S | | Clomazone | | |
| No. | Parameter | 500 g/ha | | Conclusion |
| 1 | Assessment type | Percentage control | | |
| | | Calc | Actual | |
| 2 | Ipomoea grandifolia, 7 DAA @ | Calc | Actual | Synergistic |
| | 50% Ratio 1 (post-emergence) | 98.6 | 99.0 | |
| 3 | Ipomoea grandifolia, 7 DAA | Calc | Actual | Synergistic |
| | @ 50% Ratio 2 (post- | 97.6 | 99.0 | |
| | emergence) | | | |
| 4 | Ipomoea grandifolia, 7 DAA @ | Calc | Actual | Synergistic |
| | 50% Ratio 3 (post-emergence) | 97.6 | 99.0 | |
| 5 | Brachiaria decumbens 7 DAA | 92.0 | 93.0 | Synergistic |
| | @ 50% Ratio 1 (post-emergence) | | | |
| 6 | Brachiaria decumbens 7 DAA | 95.9 | 97.7 | Synergistic |
| | @ 75% Ratio 1 (post-emergence) | | | |
| 7 | Brachiaria decumbens 7 DAA | 87.0 | 90.3 | Synergistic |
| | @ 50% Ratio 2 (post-emergence) | | | |
| 8 | Brachiaria decumbens 7 DAA | 87.4 | 93.3 | Synergistic |
| | @ 50% Ratio 3 (post-emergence) | | | |
| 9 | Brachiaria decumbens 7 DAA | 94.5 | 94.7 | Synergistic |
| | @ 75% Ratio 3 (post-emergence) | | | |
| 10 | Brachiaria decumbens 14 DAA | 85.1 | 95.3 | Synergistic |
| | @ 50% Ratio 1 (post-emergence) | | | |
| 11 | Brachiaria decumbens 14 DAA | 95.9 | 100 | Synergistic |
| | @ 75% Ratio 1 (post-emergence) | | | |
| 12 | Brachiaria decumbens 14 DAA | 86.0 | 90.7 | Synergistic |
| | @ 50% Ratio 2 (post-emergence) | | | |
| 13 | Brachiaria decumbens 14 DAA | 92.7 | 97.7 | Synergistic |
| | @ 75% Ratio 2 (post-emergence) | | | |
| 14 | Brachiaria decumbens 14 DAA | 87.6 | 97.7 | Synergistic |
| | @ 50% Ratio 3 (post-emergence) | | | |
| 15 | Brachiaria decumbens 14 DAA | 93.6 | 97.7 | Synergistic |
| | @ 75% Ratio 3 (post-emergence) | | | |
| 16 | Brachiaria decumbens 21 DAA | 74.3 | 92.0 | Synergistic |
| | @ 50% Ratio 1 (post-emergence) | | | |
| 17 | Brachiaria decumbens 21 DAA | 93.5 | 100.0 | Synergistic |
| | @ 75% Ratio 1 (post-emergence) | | | |
| 18 | Brachiaria decumbens 21 DAA | 72.2 | 80.7 | Synergistic |
| | @ 50% Ratio 2 (post-emergence) | | | |
| 19 | Brachiaria decumbens 21 DAA | 87.8 | 96.0 | Synergistic |
| | @ 75% Ratio 2 (post-emergence) | | | |
| 20 | Brachiaria decumbens 21 DAA | 72.2 | 92.3 | Synergistic |
| | @ 50% Ratio 3 (post-emergence) | | | |
| 21 | Brachiaria decumbens 21 DAA | 89.3 | 97.0 | Synergistic |
| | @ 75% Ratio 3 (post-emergence) | | | |
| 22 | Brachiaria decumbens 28 DAA | 70.2 | 92.0 | Synergistic |
| | @ 50% Ratio 1 (post-emergence) | | | |
| 23 | Brachiaria decumbens 28 DAA | 92.2 | 100.0 | Synergistic |
| | @ 75% Ratio 1 (post-emergence) | | | |
| 24 | Brachiaria decumbens 28 DAA | 67.9 | 75.0 | Synergistic |
| | @ 50% Ratio 2 (post-emergence) | | | |
| 25 | Brachiaria decumbens 28 DAA | 85.7 | 97.0 | Synergistic |
| | @ 75% Ratio 2 (post-emergence) | | | |
| 26 | Brachiaria decumbens 28 DAA | 68.6 | 93.0 | Synergistic |
| | @ 50% Ratio 3 (post-emergence) | | | |
| 27 | Brachiaria decumbens 28 DAA | 87.8 | 97.0 | Synergistic |
| | @ 75% Ratio 3 (post-emergence) | | | |

Dry weight (% Abbott), Percentage from check
(untreated) vs. Colby predicted

| | | | | |
|---|---|---|---|---|
| 28 | @ 50% Ratio 1 (post- | 41.4 | 77.9 | Synergistic |
| | emergence) | | | |
| 29 | @ 75% Ratio 1 (post- | 88.6 | 100.0 | Synergistic |
| | emergence) | | | |
| 30 | @ 50% Ratio 2 (post- | 44.6 | 53.3 | Synergistic |
| | emergence) | | | |
| 31 | @ 75% Ratio 2 (post- | 74.7 | 95.0 | Synergistic |
| | emergence) | | | |
| 32 | @ 50% Ratio 3 (post- | 48.4 | 73.8 | Synergistic |
| | emergence) | | | |
| 33 | @ 75% Ratio 3 (post- | 74.7 | 92.8 | Synergistic |
| | emergence) | | | |

Assessment type - Percentage control

| | | | | |
|---|---|---|---|---|
| 34 | Euphorbia heterophylla 7 DAA | 97.3 | 97.7 | Synergistic |
| | @ 50% Ratio 1 (post-emergence) | | | |
| 35 | Euphorbia heterophylla 7 DAA | 96.0 | 98.3 | Synergistic |
| | @ 50% Ratio 2 (post-emergence) | | | |
| 36 | Euphorbia heterophylla 7 DAA | 96.1 | 97.7 | Synergistic |
| | @ 50% Ratio 3 (post-emergence) | | | |
| 37 | Euphorbia heterophylla 14 DAA | 99.6 | 100.0 | Synergistic |
| | @ 75% Ratio 1 (post-emergence) | | | |
| 38 | Euphorbia heterophylla 14 DAA | 94.4 | 98.3 | Synergistic |
| | @ 50% Ratio 2 (post-emergence) | | | |
| 39 | Euphorbia heterophylla 14 DAA | 98.4 | 99.3 | Synergistic |
| | @ 75% Ratio 2 (post-emergence) | | | |
| 40 | Euphorbia heterophylla 14 DAA | 94.3 | 97.7 | Synergistic |
| | @ 50% Ratio 3 (post-emergence) | | | |
| 41 | Euphorbia heterophylla 14 DAA | 98.5 | 100.0 | Synergistic |
| | @ 75% Ratio 3 (post-emergence) | | | |
| 42 | Euphorbia heterophylla 21 DAA | 93.8 | 95.0 | Synergistic |
| | @ 50% Ratio 1 (post-emergence) | | | |
| 43 | Euphorbia heterophylla 21 DAA | 98.8 | 100.0 | Synergistic |
| | @ 75% Ratio 1 (post-emergence) | | | |
| 44 | Euphorbia heterophylla 21 DAA | 89.8 | 97.0 | Synergistic |
| | @ 50% Ratio 2 (post-emergence) | | | |
| 45 | Euphorbia heterophylla 21 DAA | 94.3 | 98.3 | Synergistic |
| | @ 75% Ratio 2 (post-emergence) | | | |
| 46 | Euphorbia heterophylla 21 DAA | 90.3 | 95.3 | Synergistic |
| | @ 50% Ratio 3 (post-emergence) | | | |
| 47 | Euphorbia heterophylla 21 DAA | 94.3 | 99.3 | Synergistic |
| | @ 75% Ratio 3 (post-emergence) | | | |
| 48 | Euphorbia heterophylla 28 DAA | 98.2 | 100.0 | Synergistic |
| | @ 75% Ratio 1 (post-emergence) | | | |
| 49 | Euphorbia heterophylla 28 DAA | 87.4 | 96.0 | Synergistic |
| | @ 50% Ratio 2 (post-emergence) | | | |
| 50 | Euphorbia heterophylla 28 DAA | 90.8 | 98.7 | Synergistic |
| | @ 75% Ratio 2 (post-emergence) | | | |
| 51 | Euphorbia heterophylla 28 DAA | 87.9 | 93.7 | Synergistic |
| | @ 50% Ratio 3 (post-emergence) | | | |
| 52 | Euphorbia heterophylla 28 DAA | 91.1 | 99.0 | Synergistic |
| | @ 75% Ratio 3 (post-emergence) | | | |

Dry weight (% Abbott), Percentage from check
(untreated) vs. Colby predicted

| | | | | |
|---|---|---|---|---|
| 53 | @ 75% Ratio 1 (post- | 99.1 | 99.6 | Synergistic |
| | emergence) | | | |
| 54 | @ 50% Ratio 2 (post- | 92.8 | 94.7 | Synergistic |
| | emergence) | | | |
| 55 | @ 75% Ratio 2 (post- | 95.0 | 98.6 | Synergistic |
| | emergence) | | | |
| 56 | @ 75% Ratio 3 (post- | 95.9 | 99.3 | Synergistic |
| | emergence) | | | |

Assessment type - Percentage control

| | | | | |
|---|---|---|---|---|
| 57 | Ipomoea grandifolia pre- | 56.7 | 90.3 | Synergistic |
| | emergence @ 7 DAA @ 50% | | | |
| | Ratio 1 | | | |
| 58 | Ipomoea grandifolia pre- | 82.8 | 94.3 | Synergistic |
| | emergence @ 7 DAA @ 75% | | | |
| | Ratio 1 | | | |
| 59 | Ipomoea grandifolia pre- | 45.8 | 86.3 | Synergistic |
| | emergence @ 7 DAA @ 50% | | | |
| | Ratio 2 | | | |
| 60 | Ipomoea grandifolia pre- | 79.3 | 86.0 | Synergistic |
| | emergence @ 7 DAA @ 75% | | | |
| | Ratio 2 | | | |
| 61 | Ipomoea grandifolia pre- | 56.9 | 86.0 | Synergistic |
| | emergence @ 7 DAA @ 50% | | | |
| | Ratio 3 | | | |
| 62 | Ipomoea grandifolia pre- | 79.3 | 87.7 | Synergistic |
| | emergence @ 7 DAA @ 75% | | | |
| | Ratio 3 | | | |
| 63 | Ipomoea grandifolia pre- | 74.8 | 96.3 | Synergistic |
| | emergence @ 14 DAA @ 50% | | | |
| | Ratio 1 | | | |
| 64 | Ipomoea grandifolia pre- | 92.1 | 97.7 | Synergistic |
| | emergence @ 14 DAA @ 75% | | | |
| | Ratio 1 | | | |
| 65 | Ipomoea grandifolia pre- | 75.1 | 87.7 | Synergistic |
| | emergence @ 14 DAA @ 50% | | | |
| | Ratio 2 | | | |
| 66 | Ipomoea grandifolia pre- | 92.5 | 96.3 | Synergistic |
| | emergence @ 14 DAA @ 75% | | | |
| | Ratio 2 | | | |
| 67 | Ipomoea grandifolia pre- | 83.8 | 85.0 | Synergistic |
| | emergence @ 14 DAA @ 50% | | | |
| | Ratio 3 | | | |
| 68 | Ipomoea grandifolia pre- | 71.7 | 96.3 | Synergistic |
| | emergence @ 21 DAA @ 50% | | | |
| | Ratio 1 | | | |
| 69 | Ipomoea grandifolia pre- | 95.4 | 98.3 | Synergistic |
| | emergence @ 21 DAA @ 75% | | | |
| | Ratio 1 | | | |
| 70 | Ipomoea grandifolia pre- | 73.3 | 89.3 | Synergistic |
| | emergence @ 21 DAA @ 50% | | | |
| | Ratio 2 | | | |
| 71 | Ipomoea grandifolia pre- | 71.7 | 97.3 | Synergistic |
| | emergence @ 28 DAA @ 50% | | | |
| | Ratio 1 | | | |
| 72 | Ipomoea grandifolia pre- | 96.1 | 98.0 | Synergistic |
| | emergence @ 28 DAA @ 75% | | | |
| | Ratio 1 | | | |
| 73 | Ipomoea grandifolia pre- | 73.3 | 90.3 | Synergistic |
| | emergence @ 28 DAA @ 50% | | | |
| | Ratio 2 | | | |

Dry weight (% Abbott), Percentage from check
(untreated) vs. Colby predicted

| | | | | |
|---|---|---|---|---|
| 74 | @ 50% Ratio 1 | 63.3 | 99.6 | Synergistic |
| 75 | @ 75% Ratio 1 | 95.1 | 97.7 | Synergistic |
| 76 | @ 50% Ratio 2 | 69.7 | 93.8 | Synergistic |
| 77 | @ 75% Ratio 3 | 98.1 | 98.2 | Additive |

Assessment type - Percentage control

| | | | | |
|---|---|---|---|---|
| 78 | Brachiaria decumbens pre- | 90.7 | 91.7 | Synergistic |
| | emergence @ 7 DAA @ 50% | | | |
| | Ratio 1 | | | |
| 79 | Brachiaria decumbens pre- | 87.0 | 88.7 | Synergistic |
| | emergence @ 7 DAA @ 50% | | | |
| | Ratio 2 | | | |
| 80 | Brachiaria decumbens pre- | 97.0 | 98.0 | Synergistic |
| | emergence @ 14 DAA @ 50% | | | |
| | Ratio 2 | | | |
| 81 | Brachiaria decumbens pre- | 99.9 | 100.0 | Additive |
| | emergence @ 14 DAA @ 75% | | | |
| | Ratio 2 | | | |
| 82 | Brachiaria decumbens pre- | 98.7 | 99.3 | Synergistic |
| | emergence @ 21 DAA @ 50% | | | |
| | Ratio 1 | | | |
| 83 | Brachiaria decumbens pre- | 98.3 | 99.3 | Synergistic |
| | emergence @ 21 DAA @ 50% | | | |
| | Ratio 2 | | | |
| 84 | Euphorbia heterophylla pre- | 36.7 | 63.3 | Synergistic |
| | emergence @ 7 DAA @ 50% | | | |
| | Ratio 1 | | | |
| 85 | Euphorbia heterophylla pre- | 17.9 | 51.7 | Synergistic |
| | emergence @ 7 DAA @ 50% | | | |
| | Ratio 2 | | | |
| 86 | Euphorbia heterophylla pre- | 18.5 | 50.0 | Synergistic |
| | emergence @ 7 DAA @ 50% | | | |
| | Ratio 3 | | | |
| 87 | Euphorbia heterophylla pre- | 58.4 | 66.7 | Synergistic |
| | emergence @ 14 DAA @ 50% | | | |
| | Ratio 3 | | | |
| 88 | Euphorbia heterophylla pre- | 85.0 | 87.7 | Synergistic |
| | emergence @ 21 DAA @ 50% | | | |
| | Ratio 1 | | | |
| 89 | Euphorbia heterophylla pre- | 44.5 | 71.7 | Synergistic |
| | emergence @ 21 DAA @ 50% | | | |
| | Ratio 2 | | | |
| 90 | Euphorbia heterophylla pre- | 50.7 | 70.0 | Synergistic |
| | emergence @ 21 DAA @ 50% | | | |
| | Ratio 3 | | | |
| 91 | Euphorbia heterophylla pre- | 44.9 | 70.0 | Synergistic |
| | emergence @ 28 DAA @ 50% | | | |
| | Ratio 2 | | | |
| 92 | Euphorbia heterophylla pre- | 49.6 | 70.0 | Synergistic |
| | emergence @ 28 DAA @ 50% | | | |
| | Ratio 3 | | | |

### Example 2

### The Herbicidal Formulations According to the Present Invention are as Provided as Follows

| | | Dose g ai/ha of | | |
|---|---|---|---|---|
| | | Glufosinate + | | |
| | | Flumioxazin + | | |
| S | | Clomazone is | | |
| No. | Parameter | 200 + 27.5 + 250 | | Conclusion |
| 1 | Assessment type | Percentage control | | |
| | | Calc | Actual | |
| 2 | % Control - Conyza spp, 3 DAA | Calc | Actual | Synergistic |
| | | 86.8 | 92.8 | |
| 3 | % Control - Conyza spp, 7 DAA | Calc | Actual | Synergistic |
| | | 70.6 | 89.0 | |
| 4 | % Control - Conyza spp, 14 | Calc | Actual | Synergistic |
| | DAA | 97.6 | 99.0 | |
| | | Calc | Actual | |
| 2 | % Control - Cenchrus echinatus, | Calc | Actual | Synergistic |
| | 7 DAA | 57.6 | 91.5 | |
| 3 | % Control - Cenchrus echinatus, | Calc | Actual | Synergistic |
| | 14 DAA | 75.7 | 92.8 | |
| 4 | % Control - Cenchrus echinatus, | Calc | Actual | Synergistic |
| | 21 DAA | 78.4 | 89.3 | |
| 3 | % Control - Cenchrus echinatus, | Calc | Actual | Synergistic |
| | 28 DAA | 80.0 | 86.5 | |
| 4 | % Control - Cenchrus echinatus, | Calc | Actual | Synergistic |
| | 21 DAA | | | |

The results thereby confirmed the potential of the present herbicidal combination as a pre-emergent as well as post-emergent herbicide to kill or suppress weeds in crop fields. Thus, it can concluded that when the combination of Glufosinate, Flumioxazin and Clomazone was mixed even at a reduced dosage at 50% and 75% of the full dosage, the resultant combination showed unexpectedly enhancing the efficacy of a combination of Glufosinate, Flumioxazin and Clomazone for controlling undesired weeds.

1. A herbicidal combination comprising:
a. at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos, and shuangjiaancaolin;
b. clomazone; and
c. at least one chlorophyll and heme biosynthesis inhibitor.

2. The herbicidal combination as claimed in claim 1, wherein the organophosphorus herbicide is glufosinate.

3. The herbicidal combination as claimed in claim 1, wherein the chlorophyll and heme biosynthesis inhibitor herbicide is selected from group consisting of a triazolone herbicide, a uracil herbicide, a dicarboximide herbicide, or a pyrazole herbicide.

4. The herbicidal combination as claimed in claim 3, wherein
the triazolone herbicide is selected from the group consisting of amicarbazone, bencarbazone, carfentrazone, flucarbazone, ipfencarbazone, propoxycarbazone, sulfentrazone, and thiencarbazone;
the uracil herbicide is selected from the group consisting of benzfendizone, bromacil, butafenacil, flupropacil, isocil, lenacil, saflufenacil, terbacil, and tiafenacil;
the dicarboximide herbicide is selected from the group consisting of cinidon-ethyl, flumezin, flumiclorac, flumioxazin, and flumipropyn; and
the pyrazole herbicide is selected from the group consisting of azimsulfuron, cyclopyranil, difenzoquat, halosulfuron, metazachlor, flazasulfuron, metazosulfuron, pyrazosulfuron, pyraclonil, pyroxasulfone, benzofenap, pyrasulfotole, pyrazolynate, pyrazoxyfen, tolpyralate, topramezone, fluazolate, nipyraclofen, pinoxaden, and pyraflufen.

5. The herbicidal combination as claimed in claim 1, wherein the chlorophyll and heme biosynthesis inhibitor herbicide is selected from the group consisting of carfentrazone, amicarbazone, flucarbazone, sulfentrazone, bromacil, saflufenacil, flumioxazin, halosulfuron, flazasulfuron, pyrazosulfuron, metazachlor, amicarbazone, pinoxaden, and pyraflufen.

6. The herbicidal combination as claimed in claim 1, wherein the chlorophyll and heme biosynthesis inhibitor herbicide is flumioxazin.

7. A composition comprising:
a. at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos and shuangjiaancaolin;
b. clomazone;
c. at least one chlorophyll and heme biosynthesis inhibitor; and
d. at least one agrochemically acceptable excipient.

8. A method of controlling weeds at a locus by applying the combination of claim 1.

9. The combination of claim 1, further comprising an herbicide, an insecticide, a fungicide, a biological agent, a plant growth activator, a fertilizer, or a combination thereof.

10. The combination of claim 1, wherein the organophosphorous herbicide, clomazone and chlorophyll and heme biosynthesis inhibitor are in ratio of (1-80):(1-80):(1-80).

11. The combination of claim 10, wherein the ratio is 1.0:0.175:1.25; or 1.0:0.138:1.25; or 1.0:0.138:1.875.

12. A method of controlling the weeds selected from but Brachiaria decumbens, Conyza spp. and Cenchrus echinatus, Ipomoea grandifolia, Euphorbia heterophylla said method comprising applying at the locus of the plant the combination of claim 1.

13. The method of claim 12, wherein the weed is in pre-emergent state.

14. The method of claim 12, wherein the organophosphorus herbicide is glufosinate.

15. The method of claim 12, wherein the chlorophyll and heme biosynthesis inhibitor herbicide is selected from group consisting of a triazolone herbicide, a uracil herbicide, a dicarboximide herbicide, or a pyrazole herbicide.

16. The herbicidal combination of claim 15 wherein
the triazolone herbicide is selected from the group consisting of amicarbazone, bencarbazone, carfentrazone, flucarbazone, ipfencarbazone, propoxycarbazone, sulfentrazone, and thiencarbazone;
the uracil herbicide is selected from the group consisting of benzfendizone, bromacil, butafenacil, flupropacil, isocil, lenacil, saflufenacil, terbacil, and tiafenacil;
the dicarboximide herbicide is selected from the group consisting of cinidon-ethyl, flumezin, flumiclorac, flumioxazin, and flumipropyn; and
the pyrazole herbicide is selected from the group consisting of azimsulfuron, cyclopyranil, difenzoquat, halosulfuron, metazachlor, flazasulfuron, metazosulfuron, pyrazosulfuron, pyraclonil, pyroxasulfone, benzofenap, pyrasulfotole, pyrazolynate, pyrazoxyfen, tolpyralate, topramezone, fluazolate, nipyraclofen, pinoxaden, and pyraflufen.

17. The herbicidal combination as claimed in claim 12, wherein the chlorophyll and heme biosynthesis inhibitor herbicide is selected from the group consisting of carfentrazone, amicarbazone, flucarbazone, sulfentrazone, bromacil, saflufenacil, flumioxazin, halosulfuron, flazasulfuron, pyrazosulfuron, metazachlor, amicarbazone, pinoxaden, and pyraflufen.

18. The herbicidal combination as claimed in claim 12, wherein the chlorophyll and heme biosynthesis inhibitor herbicide is flumioxazin.

19. A kit-of-parts comprising a plurality of components, wherein said plurality of components comprises:
a. at least one organophosphorus herbicide selected from amiprofos-methyl, amiprophos, anilofos, bensulide, bilanafos, butamifos, clacyfos, 2,4-DEP, DMPA, EBEP, fosamine, glufosinate, glufosinate-P, glyphosate, huangcaoling, piperophos, and shuangjiaancaolin;
b. clomazone; and
c. at least one chlorophyll and heme biosynthesis inhibitor.

20. The kit-of-parts of claim 19, further comprising an instructions manual, said instructions manual comprising instructions directing a user to admix the components before being used.

21. The kit-of-parts of claim 19, wherein the organophosphorus herbicide is glufosinate.

22. The kit-of-parts of claim 19, wherein the chlorophyll and heme biosynthesis inhibitor herbicide is selected from the group consisting of a triazolone herbicide, a uracil herbicide, a dicarboximide herbicide, and a pyrazole herbicide.

23. The kit-of-parts as claimed in claim 22, wherein
The triazolone herbicide is selected from the group consisting of amicarbazone, bencarbazone, carfentrazone, flucarbazone, ipfencarbazone, propoxycarbazone, sulfentrazone, and thiencarbazone,
the uracil herbicide is selected from the group consisting of benzfendizone, bromacil, butafenacil, flupropacil, isocil, lenacil, saflufenacil, terbacil and tiafenacil;
the dicarboximide herbicide is selected from the group consisting of cinidon-ethyl, flumezin, flumiclorac, flumioxazin, and flumipropyn; and
the pyrazole herbicide is selected from the group consisting of azimsulfuron, cyclopyranil, difenzoquat, halosulfuron, metazachlor, flazasulfuron, metazosulfuron, pyrazosulfuron, pyraclonil, pyroxasulfone, benzofenap, pyrasulfotole, pyrazolynate, pyrazoxyfen, tolpyralate, topramezone, fluazolatc, nipyraclofcn, pinoxaden, and pyraflufen.

24. The kit-of-parts as claimed in claim 19, wherein chlorophyll and heme biosynthesis inhibitor herbicide is selected from the group consisting of carfentrazone, amicarbazone, flucarbazone, sulfentrazone, bromacil, saflufenacil, flumioxazin, halosulfuron, flazasulfuron, pyrazosulfuron, metazachlor, amicarbazone, pinoxaden, and pyraflufen.

25. The kit-of-parts of claim 19, wherein the chlorophyll and heme biosynthesis inhibitor herbicide is flumioxazin.
